(19) United States
(12) Patent Application Publication
(10) Pub. No.: US 2016/0375932 A1
(43) Pub. Date: Dec. 29, 2016

(54) METHOD FOR DETECTING VEHICLE COLLISION

(71) Applicant: HYUNDAI MOTOR COMPANY, Seoul (KR)

(72) Inventor: Ji Hyun YOON, Seoul (KR)

(21) Appl. No.: 14/945,957

(22) Filed: Nov. 19, 2015

(30) Foreign Application Priority Data
Jun. 24, 2015 (KR) 10-2015-0089630

(51) Int. Cl. B62D 15/02

(52) U.S. Cl. CPC B62D 15/028; B62D 15/029; B62D 15/021

(57) ABSTRACT

A method for detecting a vehicle collision includes a rear sensor provided at a rear of the vehicle figuring out a position of an obstacle, a controller of the vehicle accumulating the position of the obstacle recognized by the rear sensor to generate obstacle map data, and the controller signaling an alarm in the vehicle in the case in which a distance between the obstacle map data and the vehicle is a predetermined distance or less or in the case in which movement of the vehicle is decided through a current position of the vehicle, steering of the driver, a wheel speed, and a gear input and there is a collision risk between the vehicle and the obstacle.

### CROSS-REFERENCE TO RELATED APPLICATION

This application claims the benefit of priority to Korean Patent Application No. 10-2015-0089630, filed on Jun. 24, 2015 with the Korean Intellectual Property Office, the disclosure of which is incorporated herein in its entirety by reference.

### TECHNICAL FIELD

The present disclosure relates to a method for detecting a vehicle collision, and more particularly, to a technology of decreasing a collision risk between a vehicle and an obstacle at the time of parking the vehicle.

### BACKGROUND

Recently, many functions have been included in a vehicle. An air bag for driver safety, a sensor allowing a safe distance to be maintained, and the like, have been included in vehicles. In addition, sensors are mounted in order to prevent collisions with another vehicle at the time of parking the vehicle backward by giving aid to the driver.

However, a burden felt by the driver at the time of driving the vehicle is parking the vehicle between vehicles or between obstacles. Therefore, research into a system for automatically assisting in the parking of the vehicle has been actively conducted.

For example, a smart parking assist system is a system searching a parking enabled region using space searching ultrasonic sensors mounted at the front, the rear, the left, the right, and the like, of the vehicle to assist in the parking of the vehicle. Here, the driver has only to perform operations such as gear shifting, acceleration, stopping, and the like.

In addition, a parking distance control is a system allowing the driver to park the vehicle by a remote controller by recognizing a distance between the vehicle and an object through a rear perception camera representing a rotation radius trajectory of the vehicle and a plurality of sensors embedded in the front and rear bumpers of the vehicle.

However, in the case of the smart parking assist system or the parking distance control according to the related art, when an obstacle is present in a portion in which transmission regions of signals of a plurality of sensors are overlapped with each other, all of reflection signals of the respective sensors are received, such that there is a limitation that it is not decided which sensor the obstacle is closer to.

Further, a blind spot that is not recognized by an ultrasonic sensor of the smart parking assist system according to the related art is present, and in the case in which the obstacle is present in the blind spot, the driver may not recognize an accurate position of the obstacle, such that he/she is exposed to a collision risk with the obstacle.

### SUMMARY

The present disclosure has been made to solve the above-mentioned problems occurring in the prior art while advantages achieved by the prior art are maintained intact.

An aspect of the present disclosure provides a method for detecting collision of a vehicle capable of warning a driver of a collision risk by recognizing position data of an obstacle by a rear sensor of the vehicle, accumulating the recognized position data of the obstacle to build up obstacle map data, figuring out a position of the vehicle through information (a deceleration or acceleration, a position, steering, a gear, and the like, of the vehicle) that may be figured out by the driver, calculating a distance between the vehicle and the obstacle, and deciding a position of the obstacle present in a blind spot of the rear sensor of the vehicle and a distance between the obstacle and the vehicle.

According to an exemplary embodiment of the present disclosure, a method for detecting collision of a vehicle includes: a rear sensor provided at the rear of the vehicle figuring out a position of an obstacle; a controller of the vehicle accumulating the position of the obstacle recognized by the rear sensor to generate obstacle map data; the controller calculating a real-time position of the vehicle using a control input value of a driver; the controller finding a central portion of the vehicle on the basis of the calculated real-time position of the vehicle and converting a position of the vehicle from the central position of the vehicle into a polygonal shape or a multilateral shape; and the controller performing an alarm in the vehicle in the case in which a distance between the obstacle map data and the vehicle is a predetermined distance or less or in the case in which movement of the vehicle is decided through a current position of the vehicle, steering of the driver, a wheel speed, and a gear input and there is a collision risk between the vehicle and the obstacle.

The rear sensor may include an ultrasonic sensor, a radar sensor, or a LIDAR sensor.

The control input value of the driver may include a position of the vehicle, the wheel speed, the steering of the driver, or the gear input.

In the calculating of the real-time position of the vehicle, a dynamic model or a kinematics model of the vehicle may be used.

The method for detecting collision of a vehicle may further include the controller deleting and initializing the obstacle map data stored therein in the case in which the distance between the obstacle map data and the vehicle is the predetermined distance or more or in the case in which a speed of the vehicle is a predetermined speed or more.

### BRIEF DESCRIPTION OF THE DRAWINGS

The above and other objects, features and advantages of the present disclosure will be more apparent from the following detailed description taken in conjunction with the accompanying drawings.

FIG. 1 is a view for describing a method for generating obstacle map data in a system for detecting a vehicle collision according to an exemplary embodiment of the present disclosure.

FIG. 2 is a view for describing a case of predicting collision decision between a vehicle and an obstacle and warning a driver in the vehicle of the collision decision in the system for detecting a vehicle collision according to an exemplary embodiment of the present disclosure.

FIG. 3 is a view for describing a case of deleting obstacle map data in the system for detecting collision of a vehicle according to an exemplary embodiment of the present disclosure.

### DETAILED DESCRIPTION

Advantages and features of the present disclosure and methods accomplishing them will become apparent from exemplary embodiments described below in detail with reference to the accompanying drawings. However, the present disclosure is not limited to exemplary embodiments described herein, but may be implemented in other forms. These exemplary embodiments are provided in order to describe the present disclosure in detail so that those skilled in the art to which the present disclosure pertains may easily practice the spirit of the present disclosure.

In the accompanying drawings, exemplary embodiments of the present disclosure are not limited to illustrated specific forms, but are exaggerated for the purpose of clarity. Although specific terms have been used in the present specification, they are used in order to describe the present disclose and are not used in order to limit the meaning or the scope of the present disclosure, which is disclosed in the appended claims.

In the present specification, a term ‘and/or’ is used as the meaning including at least one of components arranged before and after the term. In addition, terms ‘connected/coupled’ are used as the meaning including that any component is directly connected to another component or is indirectly connected to another component through the other component. Unless explicitly described to the contrary, a singular form includes a plural form in the present specification. In addition, components, steps, operations, or elements mentioned by terms ‘include’ or ‘including’ used in the present specification mean the existence or addition of one or more other components, steps, operations, or elements.

Hereinafter, an exemplary embodiment of the present disclosure will be described in detail with reference to the accompanying drawings.

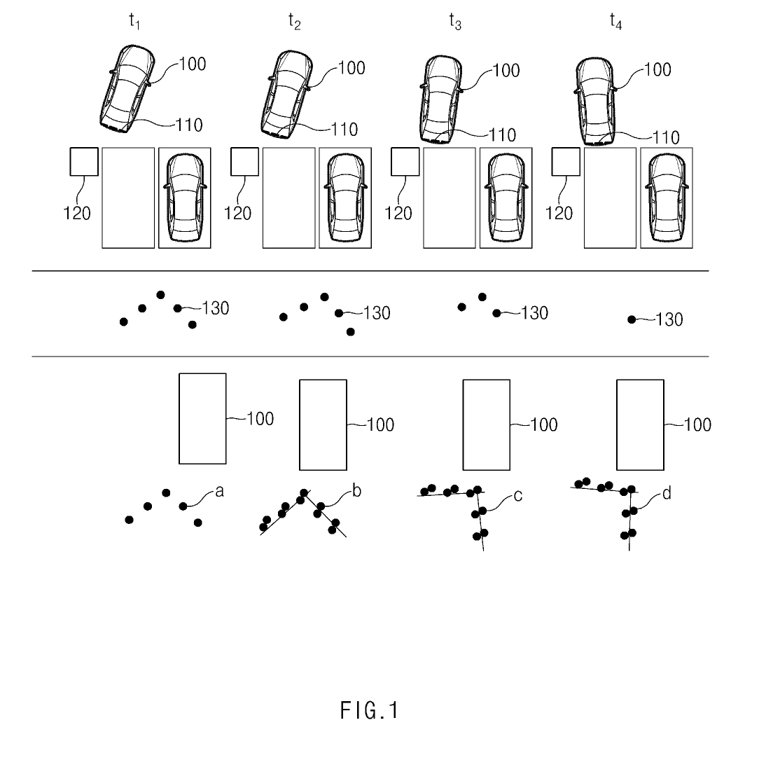

FIG. 1 is a view for describing a method for generating obstacle map data in a system for detecting a vehicle collision according to an exemplary embodiment of the present disclosure.

Referring to FIG. 1, the system for detecting a vehicle collision may include a controller, and may be applied at the time of driving a vehicle 100 at a predetermined speed or less or during parking the vehicle 100 backward.

A process of generating obstacle map data in each time t in a situation in which the vehicle 100 is parked backward will be described, and cases in which an obstacle 120 is present at the left or the right of the vehicle 100 when the vehicle 100 is parked backward will be described by way of example.

First, in a time t₁, a rear sensor 110 of the vehicle 100 recognizes a position of the obstacle 120 present at the left of the vehicle 100. That is, data on the recognized position of the obstacle 120 may be called sensor recognized data 130 or sensed data. The data on the recognized position of the obstacle 120 may be represented by a plurality of points.

In the system for detecting a vehicle collision, the controller accumulates the position (sensor recognized data 130) of the obstacle to generate obstacle map data a.

Next, in a time t₂, the rear sensor 110 of the vehicle 100 continuously recognizes the position of the obstacle 120 present at the left of the vehicle 100 to generate obstacle map data b.

Here, the controller accumulates the obstacle map data b, and an amount of the obstacle map data b accumulated in the time t₂ is more than an amount of the obstacle map data a accumulated in the time t₁.

Next, in a time t₃, the rear sensor 110 of the vehicle 100 continuously recognizes the position of the obstacle 120 present at the left of the vehicle 100 to generate obstacle map data c.

Here, the controller accumulates the obstacle map data c, and an amount of the obstacle map data c accumulated in the time t₃ is more than an amount of the obstacle map data b accumulated in the time t₂.

Next, in a time t₄, the rear sensor 110 of the vehicle 100 continuously recognizes the position of the obstacle 120 present at the left of the vehicle 100 to generate obstacle map data d.

Here, the controller accumulates the obstacle map data d, and an amount of the obstacle map data d accumulated in the time t₄ is more than an amount of the obstacle map data c accumulated in the time t₃.

Here, it may be confirmed that the position of the obstacle map data of the controller from the time t₁ to the time t₄ is updated during movement of the vehicle, which represents a relative position of the obstacle in relation to the position of the vehicle. The relative position of the obstacle is updated depending on a movement level of the vehicle. The movement level of the vehicle is a value estimated by a control input value (steering, a wheel speed, a gear, or the like, of the vehicle) of the vehicle since it may be difficult to use a global positioning system (GPS).

For example, when the relative position of the obstacle is (−3, −5) on an X axis and a Y axis and an estimation value of movement of the vehicle is 1 meter in a backward direction of a longitudinal direction of the vehicle and 1 meter in a right direction of a transversal direction of the vehicle, a position of the vehicle is (0, 0) on the X axis and the Y axis, and a relative position of an obstacle map is (−2, −4).

Here, an operation method of the system for detecting a vehicle collision will be described in detail below.

First, the system for detecting a vehicle collision figures out a position of the obstacle using the rear sensor included in the vehicle in the case in which a driver drives the vehicle at a predetermined speed or less and parks the vehicle backward. Here, as the rear sensor, an ultrasonic sensor, a radar sensor, a LIDAR sensor, or the like, may be used.

Next, the controller included in the system for detecting a vehicle collision accumulates the position of the obstacle recognized by the rear sensor whenever the vehicle moves, thereby generating the obstacle map data.

Next, the controller calculates a real-time position of the vehicle using a control input value (a current position of the vehicle, steering of the driver, a gear input, or the like) of the driver.

Here, in a detailed method of calculating the real-time position of the vehicle, a dynamic model of the vehicle or a kinematics model of the vehicle is used.

Here, the dynamic model of the vehicle or the kinematics model of the vehicle is a generally used model, and in the method of calculating the real-time position of the vehicle, the following Equation 1 may be used:

$$x = {u}_{s} cos Θ \\ y = {u}_{s} sin Θ \\ Θ = \frac{{u}_{s}}{L} tan u φ . \qquad [ Equation 1 ]$$

Here, Uₛ indicates a movement distance of the vehicle, which is calculated by a wheel speed of the vehicle. Also, x means a longitudinal direction of the vehicle, y means a transversal direction of the vehicle, θ means a direction of the vehicle, L means a distance between wheels of the vehicle, and uΦ means an angle of the wheels. A detailed description for the dynamic model or the kinematics model of the vehicle will be omitted.

Next, the controller finds movement displacements (in the longitudinal direction and the transversal direction) of the vehicle using the dynamic model of the vehicle or the kinematics model of the vehicle, and the position of the vehicle is converted into a polygonal shape or a multilateral shape on the basis of specifications of the vehicle from a central portion of the vehicle.

Next, in the case in which a distance between the obstacle map data and the vehicle is a predetermined distance or less or in the case in which the movement of the vehicle is predicted depending on the current position of the vehicle, the steering of the driver, the wheel speed, and the gear and there is a collision risk between the vehicle and the obstacle, the controller sets off an alarm in the vehicle to give a warning to the driver.

However, in the case in which the distance between the obstacle map data and the vehicle is the predetermined distance or more or a speed of the vehicle is a predetermined speed or more, the controller decides that the driver does not intend to park the vehicle, thereby deleting and initializing the obstacle map data stored in the controller.

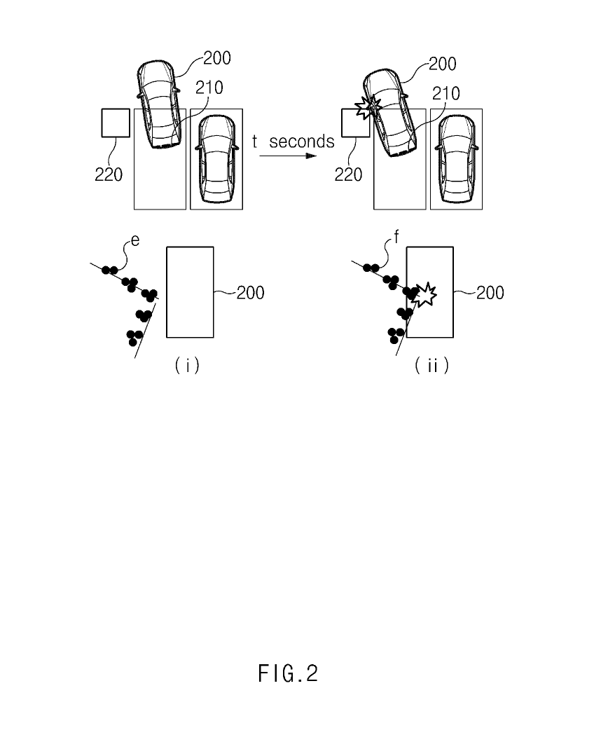

FIG. 2 is a view for describing a case of predicting a collision decision between the vehicle and an obstacle and warning a driver in the vehicle of the collision decision in the system for detecting a vehicle collision according to an exemplary embodiment of the present disclosure.

Referring to (i) and (ii) of FIG. 2, a case in which an obstacle 220 is present at the left or the right of a vehicle 200 when the vehicle 200 is parked backward will be described by way of example.

Here, since a rear sensor 210 of the vehicle 200 does not recognize a position of the obstacle 220 present at the left or the right of the vehicle 200 any more unlike FIG. 1, the controller of the system for detecting a vehicle collision may estimate movement of the vehicle 200 after t seconds through accumulated obstacle map data e and f and a current position of the vehicle, steering of the driver, a wheel speed, a gear, and the like, thereby deciding whether or not the vehicle 200 and the obstacle 220 will collide with each other.

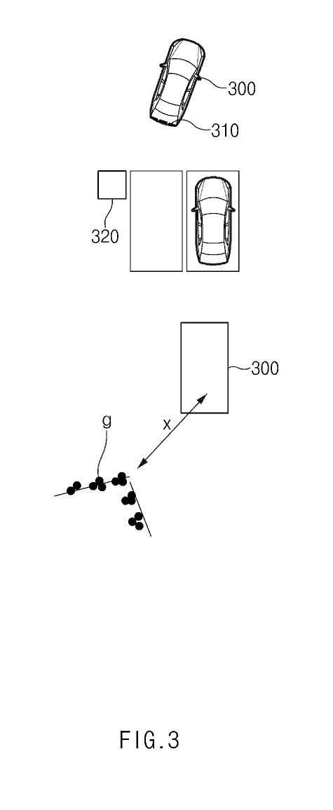

FIG. 3 is a view for describing a case of deleting obstacle map data in the system for detecting a vehicle collision according to an exemplary embodiment of the present disclosure.

Referring to FIG. 3, in the case in which a distance between a vehicle 300 and an obstacle 320 is a predetermined distance x or more or a speed of the vehicle 300 is a predetermined speed or more, the controller of the system for detecting a vehicle collision deletes and initializes obstacle map data g stored therein. The distance between the vehicle 300 and the obstacle 320 is a distance set by the controller, and the set distance and speed may be set or adjusted by the driver.

As described above, in the present technology, a collision risk between the obstacle present in a blind spot of the rear sensor and the vehicle may be detected without adding sensors into the vehicle.

In addition, in the present technology, a collision accident may be prevented by detecting the collision risk of the vehicle and then warning the driver of the collision risk in advance.

Further, in the present technology, the sensors are not added into the vehicle, such that a cost of the vehicle may be decreased.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for detecting a vehicle collision, comprising:
a rear sensor provided at a rear of the vehicle figuring out a position of an obstacle;
a controller of the vehicle accumulating the position of the obstacle recognized by the rear sensor to generate obstacle map data;
the controller calculating a real-time position of the vehicle using a control input value of a driver;
the controller finding a central portion of the vehicle on the basis of the calculated real-time position of the vehicle and converting a position of the vehicle from the central position of the vehicle into a polygonal shape or a multilateral shape; and
the controller signaling an alarm in the vehicle in the case in which a distance between the obstacle map data and the vehicle is a predetermined distance or less or in the case in which movement of the vehicle is decided through a current position of the vehicle, steering of the driver, a wheel speed, and a gear input and there is a collision risk between the vehicle and the obstacle.

2. The method for detecting a vehicle collision according to claim 1, wherein the rear sensor includes an ultrasonic sensor.

3. The method for detecting a vehicle collision according to claim 1, wherein the control input value of the driver is selected from the group consisting of a position of the vehicle, the wheel speed, the steering of the driver, and the gear input.

4. The method for detecting a vehicle collision according to claim 1, wherein in the calculating of the real-time position of the vehicle, a dynamic model of the vehicle is used.

5. The method for detecting a vehicle collision according to claim 1, further comprising the controller deleting and initializing the obstacle map data stored therein in the case in which the distance between the obstacle map data and the vehicle is the predetermined distance or more or in the case in which a speed of the vehicle is a predetermined speed or more.

6. The method for detecting a vehicle collision according to claim 1, wherein in the calculating of the real-time position of the vehicle, a kinematics model of the vehicle is used.

7. The method for detecting a vehicle collision according to claim 1, wherein the rear sensor includes a radar sensor.

8. The method for detecting a vehicle collision according to claim 1, wherein the rear sensor includes a LIDAR sensor.
